(19) United States
(12) Patent Application Publication
(10) Pub. No.: US 2025/0192531 A1
(43) Pub. Date: Jun. 12, 2025

(54) ELECTRICAL JUNCTION BOX

(71) Applicant: Sumitomo Wiring Systems, Ltd., Yokkaichi-Shi (JP)

(72) Inventors: Kiyofumi KAWAGUCHI, Yokkaichi-Shi (JP); Tatsuya Fujisaka, Yokkaichi-Shi (JP)

(73) Assignee: Sumitomo Wiring Systems, Ltd., Yokkaichi-Shi (JP)

(21) Appl. No.: 18/971,768

(22) Filed: Dec. 6, 2024

(30) Foreign Application Priority Data
Dec. 7, 2023 (JP) 2023-207074

(51) Int. Cl. H02G 3/16

(52) U.S. Cl. CPC H02G 3/16

(57) ABSTRACT

Provided is an electrical junction box that is able to ensure heat dissipation within the metal housing and protect busbars from infiltration of a foreign body through a housing hole. A relay unit of an electrical junction box has a resin component forming a main body of the relay unit and to which at least a relay is attached, and a busbar attached to a resin component and used as wiring of the resin component. The metal housing has a housing hole for externally leading out a wire attached to the resin component and electrically connected to the busbar. The resin component has a heat dissipation hole for dissipating heat of the relay unit generated when current flows through the relay unit. The heat dissipation hole has, on at least part of the hole periphery, a step part located on the far side thereof as viewed from the housing hole.

### CROSS-REFERENCE TO RELATED APPLICATIONS

This application claims priority of Japanese Patent Application No. JP 2023-207074 filed on Dec. 7, 2023, the contents of which are incorporated herein.

### TECHNICAL FIELD

The present disclosure relates to an electrical junction box.

### BACKGROUND

Conventionally, electrical junction boxes in which a plurality of shielded wires are relayed by relays, fuses, and the like, as disclosed in JP 2014-212608A, are well known. The electrical junction box of JP 2014-212608A is provided with a box body having an upper case that is closed by a cover and a lower case that is attached to the back surface of the upper case. The lower case has busbars that connect a plurality of shielded wires housed within the box body through wire outlets formed in a wall surface of the upper case. The plurality of shielded wires are disposed on an upper surface of the upper case, and terminals at leading ends thereof are fixed to the busbars of the lower case by a fastening structure of bolts and nuts.

JP 2014-212608A is an example of related art.

Incidentally, in the case of shielded wires that carry high-voltage current, relays and fuses generate heat, and thus the inside of the box body tends to become hot. Also, in the case of an electrical junction box having openings such as wire outlets in the box body, the busbars need to be protected such that, even if a foreign body such as a wire infiltrates through an opening such as a wire outlet, the foreign body does not come in contact with the busbars. Therefore, it is desired to develop a technology that is able to both ensure heat dissipation within the box body and protect against infiltration of a foreign body through an opening in the box body.

An object of the present disclosure is to provide an electrical junction box that is able to both ensure heat dissipation within a metal housing and protect a busbar from infiltration of a foreign body through a housing hole.

### SUMMARY

An electrical junction box that resolves the above problem is a configuration including a relay unit for use in relay connection of an electrical wire and a metal housing housing the relay unit, in which the relay unit has a resin component forming a main body of the relay unit and to which at least a relay is attached, and a busbar attached to the resin component and used as wiring of the resin component, the metal housing has a housing hole for externally leading out an electrical wire of a connector attached to the resin component and electrically connected to the busbar, the resin component has a heat dissipation hole for dissipating heat of the relay unit generated when current flows through the relay unit, and the heat dissipation hole has, on at least part of a hole periphery, a step part located on a far side thereof as viewed from the housing hole.

The present disclosure is able to both ensure heat dissipation within the metal housing and protect the busbar from infiltration of a foreign body through the housing hole.

### BRIEF DESCRIPTION OF THE DRAWINGS

FIG. 1 is a perspective view of an electrical junction box according to one embodiment.

FIG. 2 is a cross-sectional view taken along line II-II shown in FIG. 1.

FIG. 3 is an exploded perspective view of the electrical junction box.

FIG. 4 is an enlarged perspective view of a heat dissipation hole.

FIG. 5 is an illustrative diagram showing a state in which a foreign body such as a wire has infiltrated the housing.

FIG. 6 is an illustrative diagram showing a state in which a foreign body such as a wire has infiltrated the heat dissipation hole.

FIG. 7 is an illustrative diagram showing a state in which infiltration of a foreign body such as a wire is prevented by a step part.

FIG. 8 is a partial cross-sectional view showing a discharge hole according to another example.

### DETAILED DESCRIPTION OF PREFERRED EMBODIMENTS

Initially, modes of the present disclosure will be enumerated and described.

In a first aspect, an electrical junction box of the present disclosure is a configuration including a relay unit for use in relay connection of an electrical wire and a metal housing housing the relay unit, in which the relay unit has a resin component forming a main body of the relay unit and to which at least a relay is attached, and a busbar attached to the resin component and used as wiring of the resin component, the metal housing has a housing hole for externally leading out an electrical wire of a connector attached to the resin component and electrically connected to the busbar, the resin component has a heat dissipation hole for dissipating heat of the relay unit generated when current flows through the relay unit, and the heat dissipation hole has, on at least part of a hole periphery, a step part located on a far side thereof as viewed from the housing hole.

According to this configuration, the heat dissipation hole is formed in the resin component, and thus a path for heat dissipation can be provided inside the metal housing. Thus, heat generated by the relay unit can be emitted through the housing hole to outside the metal housing via the heat dissipation hole. Also, a foreign body such as a wire that has entered through the housing hole can be prevented from infiltrating the resin component through the heat dissipation hole, by the step part of the heat dissipation hole stopping the leading end of the foreign body. Thus, the possibility of a foreign body that has infiltrated through the housing hole coming in contact with the busbar inside the resin component decreases. As described above, it becomes possible to both ensure heat dissipation within the metal housing and protect the busbar from infiltration of a foreign body through the housing hole.

In a second aspect according to the first aspect, the heat dissipation hole may have a peripheral protruding wall on a hole periphery disposed on a surface of the resin component, and the step part may be formed inside the heat dissipation hole having the protruding wall. According to this configuration, a foreign body such as a wire that has infiltrated through the housing hole can be stopped by being caught on the protruding wall. Therefore, infiltration of a foreign body into the heat dissipation hole can be further suppressed.

In a third aspect according to the first or the second aspect, the heat dissipation hole may be disposed close to the relay. According to this configuration, heat dissipated from the relay can be smoothly circulated through the heat dissipation hole located nearby. Therefore, this further contributes to ensuring heat dissipation within the metal housing.

In a fourth aspect according to any of the first through the third aspects, the heat dissipation hole may be disposed close to the housing hole. According to this configuration, heat from the heat dissipation hole can be smoothly emitted from the housing hole to outside the metal housing. Therefore, this further contributes to ensuring heat dissipation within the metal housing.

In a fifth aspect according to any of the first through the fourth aspects, the heat dissipation hole may be disposed at a lower position than a hole lower end of the housing hole in a height direction of the metal housing. According to this configuration, the distance that the housing hole is separated from the heat dissipation hole can be increased as much as possible. Therefore, infiltration of a foreign body into the heat dissipation hole can be further suppressed.

Specific examples of the present disclosure will be described below with reference to the drawings. Note that the present disclosure is not limited to these examples, and is indicated by the claims, and all changes that come within the meaning and range of equivalency of the claims are intended to be embraced therein. In the diagrams, part of the configuration may be shown in an exaggerated or simplified manner for convenience of description. Also, the dimensional ratios of various portions may differ from the actual dimensions.

### Electrical Junction Box 1

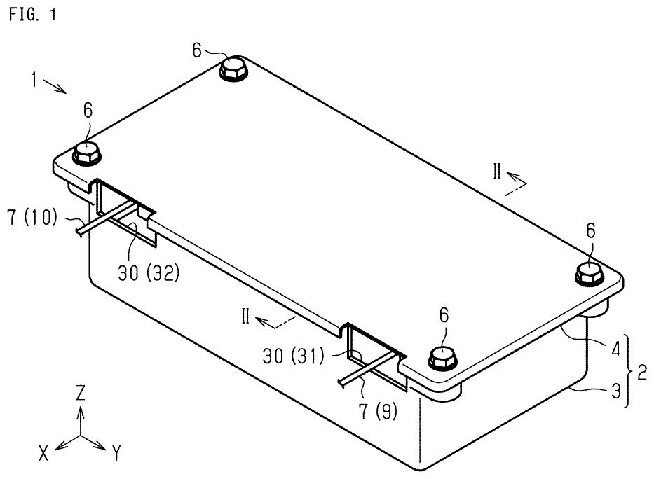

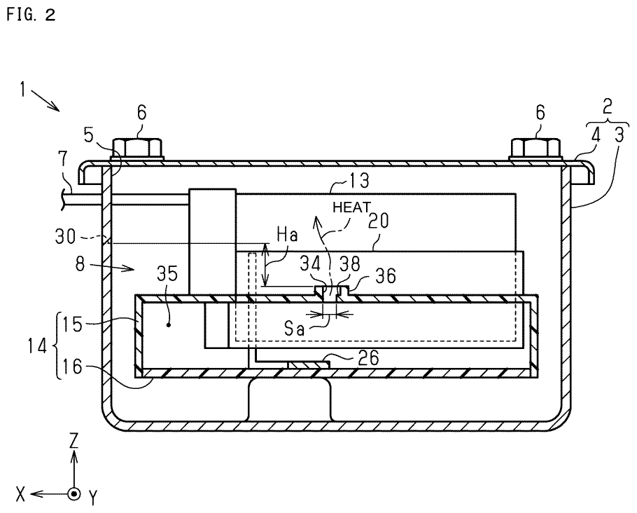

As shown in FIG. 1, an electrical junction box 1 is provided with a metal housing 2 having noise resistance as a housing of the electrical junction box 1. The metal housing 2 has, for example, a housing body 3 that forms a main body portion of the metal housing 2 and an upper cover 4 that closes an opening 5 (see FIG. 2, etc.) of the housing body 3. The housing body 3 is, for example, made of aluminum. The housing body 3 is, for example, open in an upper portion.

The upper cover 4 is, for example, formed in a rectangular plate shape. The upper cover 4 is, for example, made of iron. The upper cover 4 is, for example, fixed to the housing body 3 by a fastening member 6 such as a plurality of screws at the four corners of the upper cover 4.

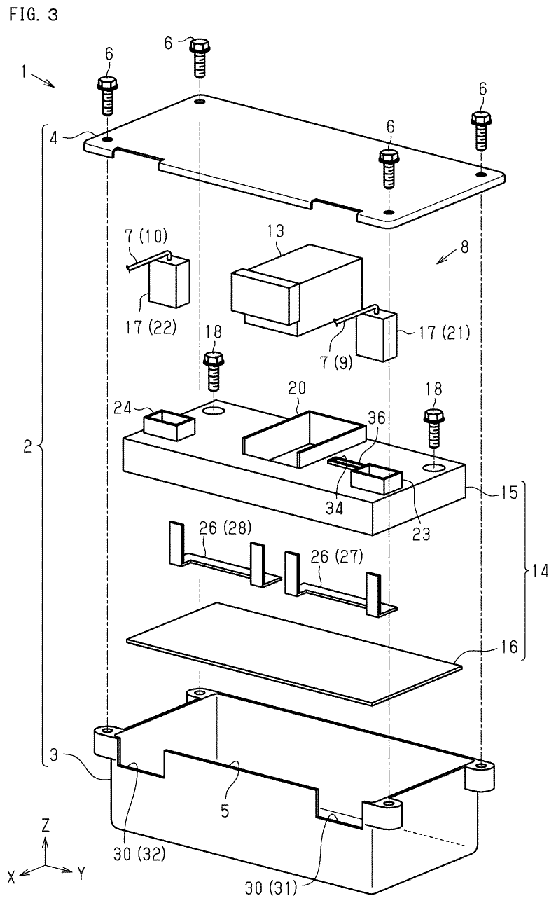

As shown in FIGS. 2 and 3, in the electrical junction box 1, a relay unit 8 that is used for relay connection of wires 7 is housed inside the metal housing 2. In this way, the electrical junction box 1 is a member that relays an electrical component joined to one wire 7 (in this example, first wire 9) and an electrical component joined to another wire 7 (in this example, second wire 10). The wires 7 are, for example, high-voltage wires. When an overvoltage or overcurrent is applied to the wires 7, for example, the electrical junction box 1 protects an electrical circuit connected to the wires 7, by using the relay unit 8 to break the electrical circuit.

### Relay Unit 8

As shown in FIGS. 2 and 3, the relay unit 8 has a resin component 14 forming a main body of the relay unit 8 and to which at least a relay 13 is attached. The resin component 14 is a member for attaching and supporting electronic components that are installed in the relay unit 8. The resin component 14 has, for example, a resin component body 15 that forms a main body of the resin component 14 and a protective cover 16 that protects the back surface of the resin component body 15. The above-mentioned relay 13, connectors 17 provided at the leading ends of the wires 7 (see FIG. 3), and the like are attached to the resin component body 15. The resin component body 15 is, for example, formed in a bottomless hollow shape. The protective cover 16 is fixed to a bottom portion of the resin component body 15 by a plurality of screws (not shown), for example. The resin component 14 is, for example, fixed to the metal housing 2 (in this example, housing body 3) by a fastening member 18 such as a plurality of screws.

The relay 13 is attached to a relay attachment part 20 formed on an upper surface of the resin component 14 at a central position in the width direction of the resin component 14 (Y-axis direction in FIG. 3). The relay 13 switches an electrical circuit having a relay function on/off with a contact (not shown) provided within a relay case. The relay 13 breaks the electrical circuit having the relay function when an overvoltage or overcurrent occurs, for example.

The connectors 17 include a first connector 21 provided at the leading end of the first wire 9 and a second connector 22 provided at the leading end of the second wire 10. The first connector 21 is attached to a first connector attachment part 23 disposed on the upper surface of the resin component 14 at one end portion in the width direction of the resin component 14 (Y-axis direction in FIG. 3). The second connector 22 is attached to a second connector attachment part 24 disposed on the upper surface of the resin component 14 at the opposite end portion in the width direction of the resin component 14 (Y-axis direction in FIG. 3).

The relay unit 8 has busbars 26 that are attached to the resin component 14 and used as wiring of the resin component 14. The busbars 26 are, for example, wiring that carries a large current. The busbars 26 are, for example, attached and fixed to the back surface of the resin component body 15 by screws (not shown). In the case of this example, the busbars 26 include, for example, a first busbar 27 that electrically connects the relay 13 and the first connector 21 and a second busbar 28 that electrically connects the relay 13 and the second connector 22.

The first wire 9 is connected to one terminal of the relay 13 via the first connector 21 and the first busbar 27. The second wire 10 is connected to the other terminal of the relay 13 via the second connector 22 and the second busbar 28. In this way, the relay unit 8 has an electrical path from the first wire 9 to the first connector 21, the first busbar 27, the relay 13, the second busbar 28, the second connector 22, and the second wire 10 in the stated order.

Note that the relay unit 8 may have a plurality of pairs of wires 7. In this case, the relay unit 8 is not limited to having only one relay 13 and may have a plurality of relays 13. The relay unit 8 may have a fuse as a measure against overcurrent on the wires 7. That is, the relay unit 8 may have both the relay 13 and a fuse. Also, the number of busbars 26 may be changed as appropriate, according to the number of relays 13 and fuses provided in the relay unit 8.

### Housing Holes 30

As shown in FIGS. 1 to 3, the metal housing 2 has housing holes 30 for externally leading out the wires 7 (in the present example, first wire 9 and second wire 10) attached to the resin component 14 and electrically connected to the busbars 26. The housing holes 30 are, for example, formed by cutting out end portions of the side wall of the housing body 3 in the height direction (+Z axis direction in FIG. 1, etc.). In the case of this example, the housing holes 30 include, for example, a first housing hole 31 for leading the first wire 9 out of the housing and a second housing hole 32 for leading the second wire 10 out of the housing. The housing holes 30 are for ventilating the metal housing 2, in order to keep the temperature within the metal housing 2 from rising.

### Heat Dissipation Measures of Resin Component 14

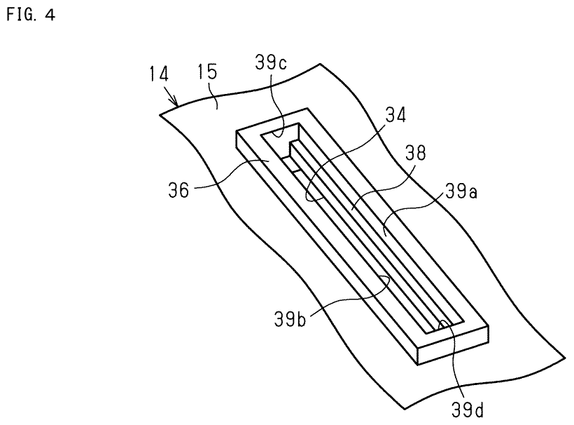

As shown in FIGS. 2 to 4, the resin component 14 has a heat dissipation hole 34 for dissipating heat of the relay unit 8 generated when current flows through the relay unit 8. The heat dissipation hole 34 is a hole through which a spatial region 35 inside the resin component 14 communicates with outside the resin component 14. The heat dissipation hole 34 has a peripheral protruding wall 36 around the hole periphery disposed on the surface of the resin component 14. The heat dissipation hole 34 is formed in a rectangular shape (see FIG. 4) as viewed from the direction of the opening of the hole (Z-axis direction in FIGS. 2, 4, etc.). There may be one heat dissipation hole 34 or a plurality thereof. The busbars 26, a fuse not shown, and the like, for example, are disposed in the spatial region 35.

As shown in FIGS. 2 and 3, the heat dissipation hole 34 is, for example, preferably disposed close to the relay 13. This is because the relay 13 tends to become hot, and heat generated by the relay 13 is efficiently dissipated via the heat dissipation hole 34. In particular, the heat dissipation hole 34 is preferably disposed upward of the busbars 26 in the height direction of the resin component 14 (Z-axis direction in FIG. 2, etc.). Note that disposing the heat dissipation hole 34 at a position close to the relay 13 means, for example, disposing the heat dissipation hole 34 directly next to the relay attachment part 20.

Also, the heat dissipation hole 34 is, for example, preferably disposed close to the housing holes 30. This is because heat from the heat dissipation hole 34 is efficiently discharged to outside the housing via the housing holes 30. Note that disposing the heat dissipation hole 34 at a position close to the housing holes 30 means, for example, disposing the heat dissipation hole 34 at a position closer to the housing holes 30 than the center in the depth direction of the resin component 14 (X-axis direction in FIG. 2, etc.).

As shown in FIGS. 2, the heat dissipation hole 34 is set to a height that is a predetermined distance Ha from the housing holes 30 in the height direction of the metal housing 2 (Z-axis direction in FIG. 2). That is, the heat dissipation hole 34 is disposed at a lower position than the hole lower ends of the housing holes 30 in the height direction of the metal housing 2. This is in order to dispose the heat dissipation hole 34 as far as possible from the housing holes 30.

As shown in FIG. 3, the heat dissipation hole 34 is provided only at a position opposing the first busbar 27, out of the first busbar 27 and the second busbar 28. Note that, in the case of this example, the heat dissipation hole 34 is provided only at a position opposing the first busbar 27, out of the first busbar 27 and the second busbar 28, but the heat dissipation hole 34 may be provided at positions respectively opposing the first busbar 27 and the second busbar 28. Also, the present embodiment is not limited to only one heat dissipation hole 34 being provided for one heat dissipation target and a plurality of heat dissipation holes 34 may be provided for one heat dissipation target.

### Step Part 38 of Heat Dissipation Hole 34

As shown in FIGS. 2 and 4, the heat dissipation hole 34 has a step part 38 formed on at least part of the hole periphery and located on the far side as viewed from the housing holes 30. The step part 38 is formed inside the protruding wall 36. As shown in FIG. 4, the step part 38 is formed along the entirety, in the width direction, of an inner peripheral surface 39a located on the far side as viewed from the housing holes 30, out of four inner peripheral surfaces 39a to 39d of the heat dissipation hole 34.

An area Sa of the opening of the heat dissipation hole 34 (see FIG. 2) not including the step part 38 is preferably set to be large enough for hot air to flow through. In the case of this example, the step part 38 is formed inside the heat dissipation hole 34, and thus the opening area Sa of the lower portion of the heat dissipation hole 34 is formed smaller than the opening in the upper portion of the heat dissipation hole 34. That is, the size of the opening of the heat dissipation hole 34 differs between the upper end and the lower end.

Next, operation of the electrical junction box 1 of the present embodiment will be described.

### Function of Heat Dissipation Hole 34

As shown in FIG. 2, when current flows through the electrical circuit of the electrical junction box 1, the relay 13 joined to the wires 7 and the busbars 26 connected to the relay 13 generate heat. The heat generated by the relay 13 and the busbars 26 accumulates in the spatial region 35 inside the resin component 14. However, in the case of this example, the heat dissipation hole 34 through which the spatial region 35 communicates with outside is formed in the resin component 14, and thus heat generated in the spatial region 35 is released to outside the spatial region 35 via the heat dissipation hole 34. Therefore, heat dissipation of the electrical junction box 1 can be improved. Accordingly, the relay 13 and the busbars 26 can be kept from becoming hot.

Also, in the case of this example, the heat dissipation hole 34 is disposed close to the housing holes 30. Thus, heat emitted to outside the spatial region 35 from the heat dissipation hole 34 is smoothly discharged to outside the metal housing 2 via the housing holes 30 disposed close to the heat dissipation hole 34. Therefore, high heat dissipation can also be satisfied in this respect.

### Design Requirement for Heat Dissipation Hole 34

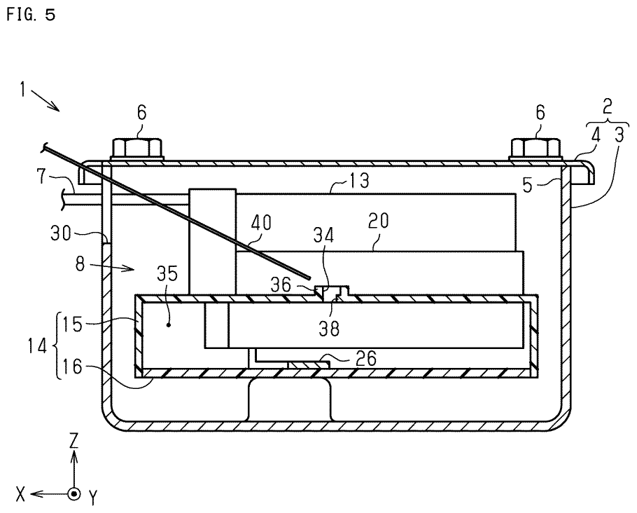

In the case where the housing holes 30 are formed in the metal housing 2, as shown in FIG. 5, there is a design requirement for insulation protection to ensure that, even if a foreign body 40 such as a wire infiltrates the metal housing 2, for example, the foreign body 40 does not contact the busbars 26. The size of the foreign body 40 such as a wire is, for example, “1 mm” in diameter and “100 mm” in length. In order to satisfy this insulation protection, the heat dissipation hole 34 must, for example, be disposed at a position away from the housing holes 30. However, adopting such a configuration results in heat emitted from the heat dissipation hole 34 not being smoothly discharged from the housing holes 30, thus making it difficult to ensure the heat dissipation effect.

Case where Step Part 38 not Provided in Heat Dissipation Hole 34

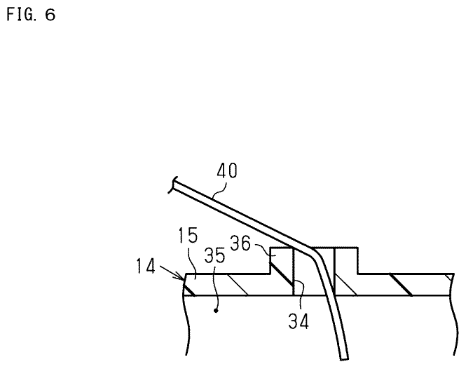

As shown in FIG. 6, if there is no step part 38 in the heat dissipation hole 34 when a foreign body 40 such as a wire that has infiltrated through the housing holes 30 enters the heat dissipation hole 34, the foreign body 40 could possibly run along the hole inner surface and transect the heat dissipation hole 34. This leads to the foreign body 40 such as a wire being exposed in the spatial region 35 through the heat dissipation hole 34 and possibly reaching the busbars 26. Therefore, if there is no step part 38 in the heat dissipation hole 34, the foreign body 40 could possibly come in contact with the busbars 26, and thus the requirement for insulation protection cannot be satisfied.

### Function of Step Part 38

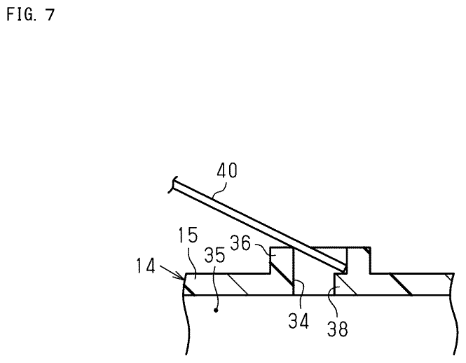

As shown in FIG. 7, if the step part 38 is in the heat dissipation hole 34 when a foreign body 40 such as a wire enters through the housing holes 30, the leading end of the foreign body 40 catches on the step part 38 of the heat dissipation hole 34. Thus, because the foreign body 40 is unable to proceed further inside past the step part 38, the foreign body 40 is prevented from infiltrating the spatial region 35. It thereby becomes possible to ensure that, even if a foreign body 40 such as a wire enters through the housing holes 30, the possibility of the foreign body 40 reaching the busbars 26 is unlikely. In this way, the design requirement for insulation protection in the electrical junction box 1 can be satisfied.

Also, in the case where the step part 38 is provided in the heat dissipation hole 34 to prevent infiltration of a foreign body 40, the heat dissipation hole 34 can be disposed as close to the housing holes 30 as possible. Heat emitted from the heat dissipation hole 34 can also thereby be smoothly discharged from the housing holes 30. Therefore, heat dissipation within the metal housing 2 can also be ensured. As described above, it becomes possible to both ensure heat dissipation within the metal housing 2 and protect the busbars 26 from infiltration of a foreign body through the housing holes 30.

### Effects of Embodiment

According to the configuration of the above embodiment, effects such as the following can be obtained.

In the electrical junction box 1, the relay unit 8 that is used in relay connection of the wires 7 is housed inside the metal housing 2. The relay unit 8 has the resin component 14 forming a main body of the relay unit 8 and to which at least the relay 13 is attached, and the busbars 26 that are attached to the resin component 14 and used as wiring of the resin component 14. The metal housing 2 has the housing holes 30 for externally leading out the wires 7 attached to the resin component 14 and electrically connected to the busbars 26. The resin component 14 has the heat dissipation hole 34 for dissipating heat of the relay unit 8 generated when current flows through the relay unit 8. The heat dissipation hole 34 has, on at least part of the hole periphery, the step part 38 located on the far side thereof as viewed from the housing holes 30.

According to the present configuration, the heat dissipation hole 34 is formed in the resin component 14, and thus a path for heat dissipation can be provided inside the metal housing 2. Thus, heat generated by the relay unit 8 can be emitted from the housing holes 30 to outside the metal housing 2 via the heat dissipation hole 34. Also, a foreign body 40 such as a wire that has entered through the housing holes 30 can be prevented from infiltrating the resin component 14 through the heat dissipation hole 34, by the step part 38 of the heat dissipation hole 34 stopping the leading end of the foreign body 40. Thus, the possibility of a foreign body 40 that has infiltrated through the housing holes 30 coming in contact with the busbars 26 inside the resin component 14 decreases. As described above, it becomes possible to both ensure heat dissipation within the metal housing 2 and protect the busbars 26 from infiltration of a foreign body through the housing holes 30.

The heat dissipation hole 34 has the peripheral protruding wall 36 on the hole periphery disposed on the surface of the resin component 14. The step part 38 is formed inside the heat dissipation hole 34 having the protruding wall 36. According to this configuration, a foreign body 40 such as a wire that has infiltrated through the housing holes 30 can be stopped by being caught on the protruding wall 36. Therefore, infiltration of a foreign body 40 into the heat dissipation hole 34 can be further suppressed.

The heat dissipation hole 34 is disposed close to the relay 13. According to this configuration, heat dissipated from the relay 13 can be smoothly circulated through the heat dissipation hole 34 located nearby. Therefore, this further contributes to ensuring heat dissipation within the metal housing 2.

The heat dissipation hole 34 is disposed close to the housing holes 30. According to this configuration, heat from the heat dissipation hole 34 can be smoothly emitted from the housing holes 30 to outside the metal housing 2. Therefore, this further contributes to ensuring heat dissipation within the metal housing 2.

The heat dissipation hole 34 is disposed at a lower position than the hole lower end of the housing holes 30 in the height direction of the metal housing 2. According to this configuration, the distance that the housing holes 30 are separated from the heat dissipation hole 34 can be increased as much as possible. Therefore, infiltration of a foreign body 40 into the heat dissipation hole 34 can be further suppressed.

### Other Embodiments

Note that the present embodiment can be implemented in a modified manner as follows. The present embodiment and the following example changes can be implemented in combination with each other to the extent that no technical inconsistencies arise.

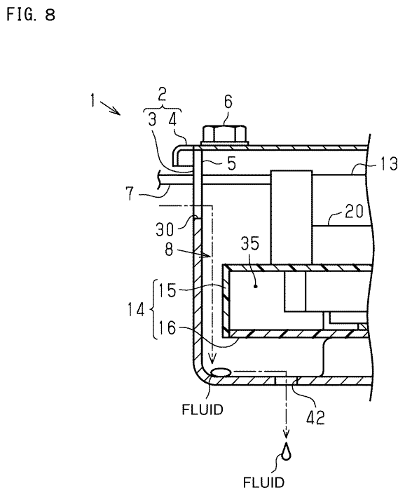

As shown in FIG. 8, the metal housing 2 may have a discharge hole 42 for externally discharging fluid that has flowed into the metal housing 2 through the housing holes 30. In this case, the fluid that has infiltrated into the metal housing 2 is discharged from the discharge hole 42 to outside the metal housing 2, and thus adhesion of the fluid to electronic components such as the busbars 26 can be suppressed.

In the case where the relay 13 and a fuse are installed in the relay unit 8, the heat dissipation target of the heat dissipation hole 34 is not limited to the relay 13 and may be the fuse. That is, the heat dissipation hole 34 is not limited to being disposed close to the wires 7 joined to the relay 13 and may be disposed close to wires 7 connected to the fuse.

The metal housing 2 is not limited to a two-component configuration and may be constituted by one component or three or more components.

The material of the metal housing 2 is not particularly limited and may be any metal.

[Heat-generating components other than the busbars 26 and fuses may be provided in the spatial region 35 of the resin component 14.

The resin component 14 is not limited to a hollow shape having the spatial region 35 and may simply be a plate shape by omitting the protective cover 16, for example.

The heat dissipation hole 34 is not limited to being formed in an upper wall of the resin component 14 and may, for example, be formed in a bottom wall or a side wall.

The heat dissipation hole 34 is not limited to externally dissipating heat within the spatial region 35 of the resin component 14. For example, when the resin component 14 is plate-shaped, that is, when the resin component 14 does not have the spatial region 35, the heat dissipation hole 34 may be constituted as a hole for allowing heat on the back side of the resin component 14 to escape to the front side.

The heat dissipation hole 34 may have a shape in which the protruding wall 36 is omitted.

When a plurality of heat dissipation holes 34 are provided, at least one thereof may be formed in a different shape from the others.

Various shapes can be employed for the hole shape of the heat dissipation hole 34, such as a slit shape, a round hole shape, an elliptical shape, a square shape, and a triangular shape.

The step part 38 may be a shape in which a plurality of protruding pieces are arranged alongside each other on one side of the hole periphery, for example.

The step part 38 may be formed around the entirety of the hole periphery.

The step part 38 need only have a shape that protrudes toward the housing holes 30 on an inner surface of the heat dissipation hole 34.

The electrical junction box 1 (relay unit 8), when connected to a plurality of electrical components, for example, may have a function of branching and relaying input to each of the electrical components.

Although the present disclosure is described in accordance with the embodiments, it is understood that the disclosure is not limited to the described embodiments and structures. The disclosure also embraces various example modifications and modifications within a range of equivalency. Additionally, various combinations and forms, as well as other combinations and forms including only one element or more or less elements, also come within the category and spirit of the disclosure.

What is claimed is:

1. An electrical junction box comprising:
a relay unit for use in relay connection of an electrical wire; and
a metal housing housing the relay unit,
wherein the relay unit has:
a resin component forming a main body of the relay unit and to which at least a relay is attached; and
a busbar attached to the resin component and used as wiring of the resin component,
the metal housing has a housing hole for externally leading out an electrical wire of a connector attached to the resin component and electrically connected to the busbar,
the resin component has a heat dissipation hole for dissipating heat of the relay unit generated when current flows through the relay unit, and
the heat dissipation hole has, on at least part of a hole periphery, a step part located on a far side thereof as viewed from the housing hole.

2. The electrical junction box according to claim 1,
wherein the heat dissipation hole has a peripheral protruding wall on a hole periphery disposed on a surface of the resin component, and
the step part is formed inside the heat dissipation hole having the protruding wall.

3. The electrical junction box according to claim 1,
wherein the heat dissipation hole is disposed close to the relay.

4. The electrical junction box according to claim 1,
wherein the heat dissipation hole is disposed close to the housing hole.

5. The electrical junction box according to claim 1,
wherein the heat dissipation hole is disposed at a lower position than a hole lower end of the housing hole in a height direction of the metal housing.
